(19) United States
(12) Patent Application Publication
(10) Pub. No.: US 2026/0088651 A1
(43) Pub. Date: Mar. 26, 2026

(54) AUTOMATED COMPLIANCE TESTING OF DISTRIBUTED ENERGY RESOURCE DEVICES

(71) Applicant: Itron, Inc., Liberty Lake, WA (US)

(72) Inventors: Richard Wallbrink, Victoria (AU); Howard Ng, Towaco, NJ (US); Thomas Kring, Concord, CA (US)

(21) Appl. No.: 19/195,391

(22) Filed: Apr. 30, 2025

Related U.S. Application Data
(60) Provisional application No. 63/697,303, filed on Sep. 20, 2024.

(51) Int. Cl. H02J 13/00; G06Q 50/06

(52) U.S. Cl. CPC H02J 13/1329; G06Q 50/06; H02J 2105/61

(57) ABSTRACT

A method for testing an electrical device installed in an energy system includes: receiving an identifier and a test identification (testID) associated with the electrical device; validating the identifier and the testID; in response to determining that the electrical device is registered and communicating: setting and storing a polling rate and a posting rate of the electrical device, setting a first plurality of pre-conditions associated with a first test, and in response to determining that the first plurality of pre-conditions is met, performing the first test by: executing a first set of test commands associated with the first test, receiving responses to the first set of test commands of the electrical device, determining first test results based on the responses to the first set of test commands, storing the first test results, and determining whether the electrical device has passed the first test.

This patent application claims benefit of priority to U.S. provisional patent application Ser. No. 63/697,303, titled “AUTOMATED COMPLIANCE TESTING OF DISTRIBUTED ENERGY RESOURCE DEVICES”, filed on Sep. 20, 2024, which is incorporated herein by reference.

### TECHNICAL FIELD

The present disclosure generally relates to the field of testing an electrical device, and more specifically to a method and system for automatically testing a field-installed electrical device, such as a distributed energy resource (DER) device, under real conditions for client specific compliance requirements.

### BACKGROUND

When an electrical device is tested, it is often tested with testing equipment designed to simulate the working environment and/or conditions associated with actual use in the field. Testing may encompass a wide range of variables, such as temperature, humidity, signal strength, signal noise, communication interference, communication interface connection protocols, mounting positions, interfacing devices, etc. However, it is difficult to simulate, or anticipate, all potential variables involved in setting up, or installing an electrical device in the field. The electrical devices, such as distributed energy resource devices, may include monitors, meters, cameras, solar inverters, electric vehicle chargers, wind turbines, batteries, or any other device that provide energy generation and/or storage. Such electrical devices may perform various functions, such as monitoring certain parameters, storing, analyzing, transmitting, and/or receiving data to and/or from other devices via one or more wired and/or wireless communication networks using various protocols, and interacting with various external devices, components, and equipment. To perform properly, devices intended for communicating with the electrical device must be compatible with the electrical device. For example, while the electrical device itself has passed all the testing in a laboratory or factory setup, the electrical device may still not be able to function properly if, based upon the following situations, other devices in communication with, or connected to, the electrical device are running operating systems untested with the electrical device; a technician installing and setting up the electrical device has not properly followed the recommended procedures; some connections to the electrical device have not been made properly; someone or something has tampered with the electrical device; another device in the area is interfering with communications with the device; etc.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features. Moreover, the figures are intended to illustrate general concepts, and not to indicate required and/or necessary elements.

FIG. 1 illustrates an example client test suite (CTS) system.

FIG. 2 illustrates a flowchart of an example installation and commissioning process of a distributed energy resource (DER) device.

FIG. 3 illustrates a first portion of a flowchart of an example processing of testing an electrical device utilizing a client test suite (CTS) designed for the client.

FIG. 4 illustrates a second portion of the flowchart of the example process of testing the electrical device utilizing the CTS designed for the client.

FIG. 5 illustrates a third portion of the flowchart of the example process of testing the electrical device utilizing the CTS designed for the client.

### DETAILED DESCRIPTION

A client test suite (CTS) is specifically designed to evaluate functionality of commands compliant with requirements of a specific client or customer for interoperability of devices associated with the specific client. The CTS is an application that performs device compliance testing and, in some examples, utilizes: an inbound application programming interface (API) call to trigger test runs (start and stop); an outbound API call to push test case reports to a utility backend or a distributed energy resource management system (DERMS); user interface (UI) to configure test cases, test suites, and test options, and to query and view test results and history; and a test engine to execute test runs of predefined test cases and interface with a utility server. The CTS May include one or more tests that cover a wide range of functionalities, including but not limited to:
Registration: tests for successful device registration with a utility server, including verification of authentication and authorization processes,
Monitoring: evaluates the accuracy and timeliness of data transmission from the distributed energy resource (DER) to the utility server, encompassing various data points like real-time power output, inverter status, and historical data retrieval,
Emergency curtailment: assesses the DER's response to emergency curtailment signals sent by the utility server, ensuring proper power reduction during critical events,
Control management: validates the DER's ability to receive and execute control commands from the utility server, such as active power control and setpoint adjustments, and/or
Additional functionalities: depending on the specific capabilities of the DER system being tested, the CTS may encompass additional functionalities as outlined in relevant industry standards.

The list of tests provided above is merely one example and in other examples the CTS may be configured to run additional and/or alternative tests. By incorporating a comprehensive set of tests, a self-contained resource for comprehensive command testing for a utility provider, such as the specific client, may be created, which ensures a standardized and thorough evaluation process, promoting interoperability and reliable communication within an energy or electrical grid of the specific client. A configurable test suite, such as the CTS, may execute pre-defined tests and analyze the results of the pre-defined tests. Additionally, the CTS can be updated to create and manage new tests as new devices are introduced, new software or firmware is introduced, and/or as new performance scenarios arise.

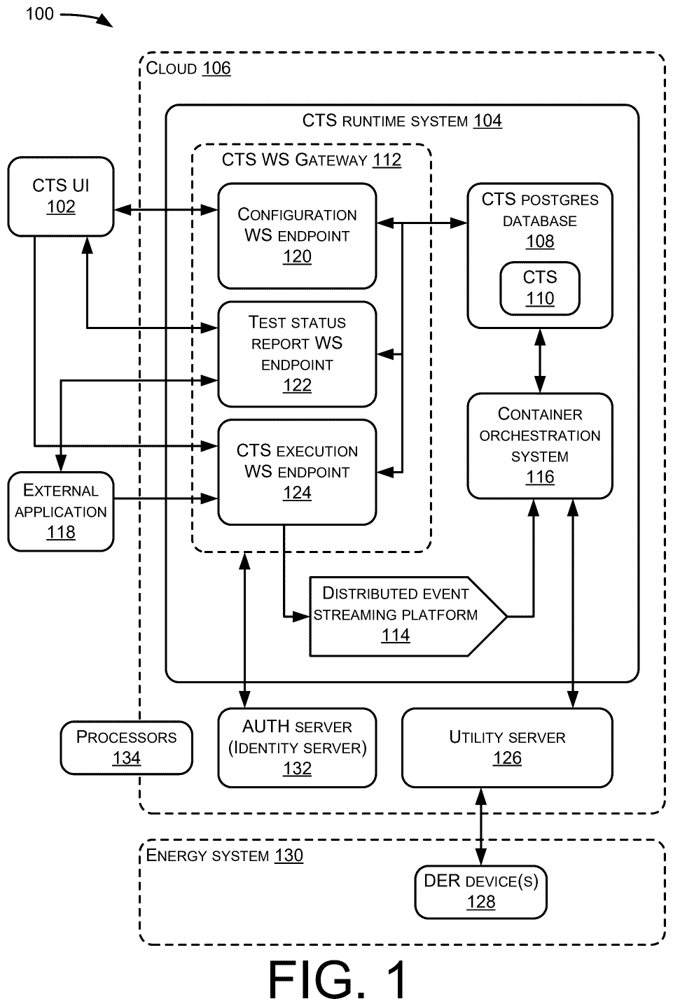

FIG. 1 illustrates an example CTS system 100 including a CTS user interface (UI) 102 and a CTS runtime system 104. The CTS UI 102, which may be hosted within or outside a cloud 106, is the primary means of creating and editing test suites. The CTS UI 102 may receive inputs from a user and provide outputs from the CTS runtime system 104. For example, the CTS UI 102 may receive instructions or commands from an installer of an electrical device to be tested and may display results and/or status associated with testing the electrical device. The CTS runtime system 104, which may be hosted in the cloud 106, may support multiple tenants as further described below. The CTS runtime system 104 may include and support one or more of: a CTS postgres database 108 storing the CTS 110, a CTS web service (WS) gateway 112, a distributed event streaming platform 114, such as a Kafka platform that is an open source, distributed streaming platform, and a container orchestration system 116, such as a Kubernetes system that is an open source software system. The CTS WS gateway 112 may interact with, and/or be utilized by, the CTS UI 102 and other external applications 118, and may include a configuration WS endpoint 120 for creating, editing, and/or updating the CTS, a test status report WS endpoint 122 for overviewing CTS execution history and tracking the status of the CTS 110, and a CTS execution WS endpoint 124 for queuing a targeted test suite, such as the one or more tests included in the CTS 110, for execution into the distributed event streaming platform 114. Once the CTS 110 is queued, the CTS execution WS endpoint 124 sends all OK response to the CTS UI 102.

The CTS runtime system 104 may dequeue the CTS from the distributed event streaming platform 114 and start executing the CTS in defined steps using defined parameters and aiming at a specified utility server, such as a utility server 126, to execute the CTS. In case the same device is subject to multiple tests included in the CTS, all tests that come in while there is a pending or active test in progress may be rejected by the CTS execution WS endpoint 124 to prevent tests running in parallel from potentially affecting each other. The device may be a DER device installed in an energy system 130, such as an electrical system or grid of a customer, such as a utility provider. Additionally, or alternatively, by using configuration settings available in the configuration WS endpoint 120, multiple CTS runtime systems, similar to the CTS runtime system 104, may be deployed for multiple tenants and potentially targeting multiple utility servers. For accessing the CTS WS gateway 112, the CTS system 100 utilizes services of an existing identity server, such as an authentication server 132. If the authentication server 132 is not available, then certificate level security may be for a given environment based on provisioned certificates. The CTS system 100 may be operated by one or more processors (processors) 134 communicatively coupled to, and associated with, the CTS system 100. The processors 134 may be located in the cloud 106, in a local system connected to the CTS system 100, the energy system 130 of the customer, or any combination of the above.

The CTS system 100 may incorporate test session management functionalities for managing the overall test execution lifecycle including an initial setup, such as recording existing communication settings between a device, such as the DER device 128, and a utility server, such as the utility server 126 or a distributed energy resource management system (DERMS), before any tests begin. The CTS system 100 may then temporarily adjust communication frequency settings to a more efficient rate, for example, one minute, for the duration of the testing process. Once the tests are complete, the original communication settings may be automatically restored to ensure no disruption to normal operations. The test session management may manage test execution based on a device type of the device being tested, such as aggregator-controlled device and directly-connected device. A system-wide timeout setting may also be included. For example, if a test session concludes without explicitly changing the communication settings, the system-wide timeout setting feature may automatically restore the communication settings, thus preventing any accidental configuration issues.

The CTS system 100 may include one or more configurable test suites, such as the CTS. The configurable test suites may provide a structured approach for grouping related tests together and allow creating multiple test suites designed for different purposes, such as commissioning new devices, performing diagnostics, and/or conducting periodic compliance checks. The configurable test suites may offer flexibility by allowing administrators to add or remove specific tests from a configurable test suite as needed. Additionally, a configurable test suite may include a version control to track any changes made to a configuration the suite over time. Administrators may also have the ability to manually execute specific test suites and define whether the entire suite should halt upon encountering a failed test (“stop-on-failure” behavior) or continue on to completion for a more comprehensive evaluation. The configurable test suites may also provide the ability to re-run only the failed tests within a particular suite after an initial execution, which may significantly reduce the time required to conduct retests and pinpoint any lingering issues. The CTS system 100 may additionally accommodate combined test cases that may be executed on either aggregator-controlled devices or directly-connected devices.

The CTS system 100 may also include one or more pre-defined test suites encompassing various functionalities relevant to the lifecycle of Distributed Energy Resources (DERs) as described below. A client DER commissioning test may be targeted for installers of DER devices, and may verify the successful installation and registration of a DER device, such as the DER device 128 installed in the energy system 130, with a utility server, such as the utility server 126, using the protocol of the client. Example functionalities of the client DER commissioning test may include: testing ability of the DER client to discover and connect to the utility server; verifying successful registration by exchanging data through messages of the DER client; ensuring the installer has configured the DER client correctly for communication with the utility server; and validating the exchange of essential data points, such as device capabilities and operational status. An installed DER periodic compliance testing may be targeted for utility service providers and DER system owners/operators, and may verify the ongoing compliance of an installed DER system with regulatory requirements or contractual agreements. Example functionalities of the installed DER periodic compliance testing may include: performing periodic checks to ensure the DER system continues to operate within specified power output limits; verifying adherence to grid interconnection standards and regulations; validating data reporting requirements as mandated by regulatory bodies or utility contracts; and detecting potential deviations from compliance that may require corrective actions.

A post-installation DER trouble shooting diagnostic testing may be targeted for installers, maintenance personnel, and DER system owners/operators, and may diagnose issues with a DER system after installation. Example functionalities of the post-installation DER trouble shooting diagnostic testing may include: testing various aspects of operation of the DER system including power generation, communication, and control functions; identifying potential problems causing malfunctions or performance issues; pinpointing root causes of failures within the DER system or its connection to the grid; and providing valuable data for troubleshooting and repairing the DER system. An original equipment manufacturer (OEM) quality assurance conformance testing may be targeted for DER device manufacturers, and may verifying if a DER device manufactured by a specific OEM adheres to the complete set of processes of the particular customer. Example functionalities of the OEM quality assurance conformance testing may include: testing the ability of the DER device to participate in all message exchanges of the particular customer; verifying that the DER device adheres to data format specifications of the particular customer for various resources; ensuring the DER device interoperates seamlessly with utility systems using the protocol of the particular customer; and identifying any deviations from the standard of the particular customer that might require adjustments in the design or firmware of the DER device. These pre-defined test suites described above may offer a comprehensive approach to managing the DER lifecycle, from initial registration and quality assurance to troubleshooting and ongoing compliance verification functionality.

Building blocks of configurable test suites are pre-defined tests, each of which encapsulates a specific testing objective and is designed to follow a defined sequence of steps. These pre-defined tests may offer detailed information that may be used to troubleshoot any failures that may occur during the testing process. In some cases, pre-defined tests may allow for customization of certain parameters to enable more tailored evaluations for specific devices or scenarios. A pre-defined test may include certain elements as described below. A unique test identification (ID) and description may provide a clear identifier and explanation associated with the test for easy reference. A pre-condition checks may provide defined actions to verify specific device states or data points before test execution begins to help ensure that the device is in a suitable condition for testing and that the results will be accurate. A sequence of control commands may provide a list of commands for the particular customer sent to the device along with corresponding parameters instructing the device to perform specific actions or retrieve data. Wait times and durations may provide defined pauses between commands and test steps to allow the device sufficient time to process commands and respond. Expected data ranges and responses may provide, for each step within the test, acceptable ranges defined for the data expected to be received from the device and used to determine whether the test step has passed or failed. A status hook may provide a stream that describes the current progress of the test case.

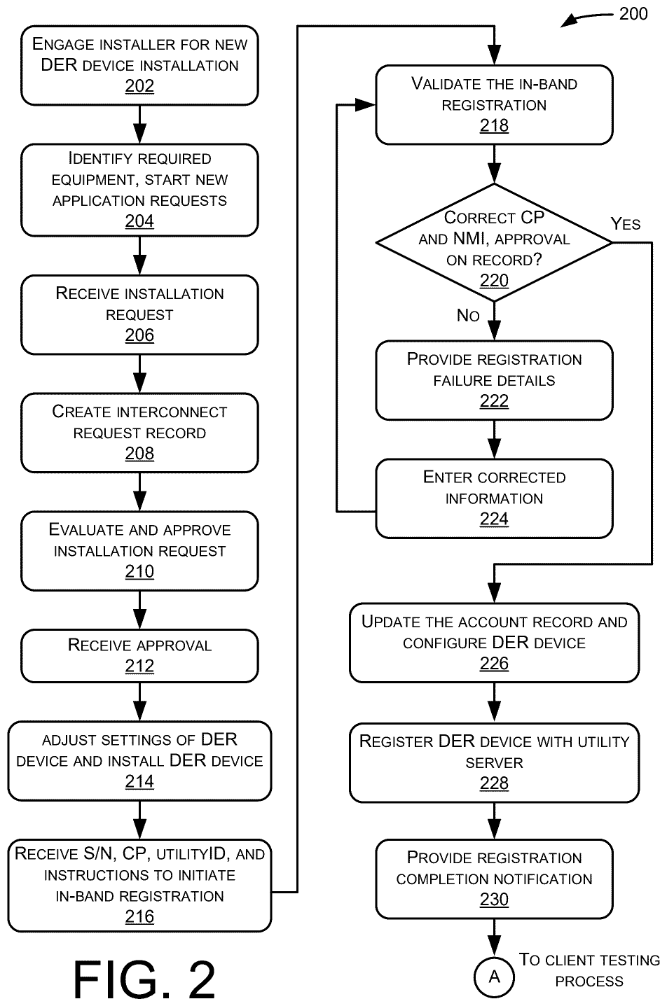

FIG. 2 illustrates a flowchart 200 of an example installation and commissioning of a DER device, such as the DER device 128. At block 202, a customer may engage an installer for installing a new DER device, such as the DER device 128, and the installer may identify required equipment and start new application requests at block 204. At block 206, the installer may enter, and an installer commissioning portal, which may be a component of the CTS UI 102, may receive, installation request including a national metering identifier (NMI) of the DER device 128, account information of the installer, and DER information associated with the DER device 128. At block 208, a DERMS, or a utility back office, may create an interconnect request record based upon the installation request received by way of the installer commissioning portal, and evaluate and approve the installation request at block 210. At block 212, the CTS UI 102, by way of the installer commissioning portal, may provide, or notify the installer, the approval of the installation request, and the DER device 128 may receive setting adjustments and be installed in an electrical system, such as the energy system 130 of the customer, at block 214. At block 216, the installer may enter, and the CTS UI 102 may receive, by way of an OEM/aggregator server portal, DER device information, such as an NMI, a serial number (S/N), a connection point (CP), a utility identification (utilityID), and instructions to initiate an in-band registration of the DER device 128. The in-band registration refers to a circumstance in which the utility server 126 does not have a client long form device identifier (LFDI) created or whitelisted ahead of time, where the LFDI is a 20-byte hash of the IEEE 2030.5 certificate of the DER device 128 used for device access control.

At block 218, the utility server 126 may validate the in-band registration based on an identification of the DER device 128, such as the LFDI, and NMI. For example, the utility server 126 may change its logic to allow registered aggregator-controlled device or directly-connected device to perform an in-band registration without whitelisting the LFDI. When new clients (aggregator-controlled devices and directly-connected devices) are added, the utility server 126 may create a device resource that does not have any topology connection and obtain a ConnectionPoint ID from the DER device 128 as part of the data exchange. At block 220, the DERMS may check the ConnectionPoint ID against an approved NMI list to confirm whether: 1) the CP is correct; and 2) there is an approval for the DER device 128. In response to determining that the CP is not correct or there is no approval at block 220, the DERMS may provide registration failure details by way of the installer commissioning portal at block 222, and the installer may re-enter, and the CTS UI 102 may receive, by way of the OEM/aggregator server portal, corrected information at block 224. The process may then be repeated from block 218 as described above. Alternatively, in response to determining at block 220 that the CP is not correct or there is no approval, the DERMS may abandon the DER device 128 and the utility server 126 may delete the DER device 128 from the record.

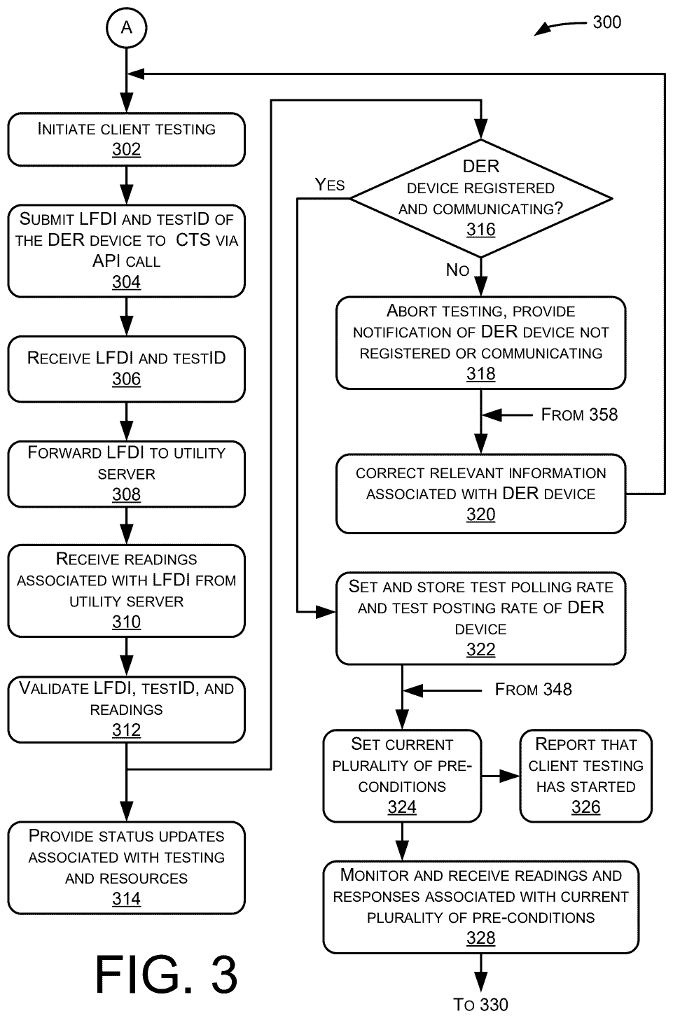

In response to determining that the CP is correct and there is an approval at block 220, the DERMS may update the account record and configure the DER device 128 at block 226, and the utility server 126 may register the DER device 128 at block 228. The CTS UI 102, by way of the installer commissioning portal, may provide a notification, such as a notification messaged display, of the registration completion at block 230. The process then proceeds to a client testing process (shown as A) as described with reference to FIGS. 3-5 below.

FIG. 3 illustrates a first portion of a flowchart 300 of an example process of testing an electrical device of a customer utilizing a client test suite (CTS), such as the CTS 110 designed for the client. At block 302, the installer may initiate the client testing, which may include one or more tests associated with the electrical device, such as the DER device 128 utilizing the CTS 110, and submit a test identification (testID) of the one or more tests and a long form device identifier (LFDI) associated with the DER device 128 installed in the energy system 130 of the customer, to the CTS 110 with an application programming interface (API) call using the installer commissioning portal at block 304. At block 306, the CTS 110 may receive the LFDI and the testID of the DER device 128, and forward the LFDI to the utility server 126 at block 308. By forwarding the LFDI to the utility server 126, the CTS 110 may cause the utility server 126 to compare the LFDI to LFDIs stored in the utility server 126. At block 310, the CTS 110 may receive, from the utility server 126, comparison results, or readings associated with the LFDI, and validate the LHDI, testID, and readings at block 312 based on the readings. The CTS 110 may additionally generate a CTS job number associated with the one or more tests, and provide the installer with status updates associated with the one or more tests and resources by way of the installer commissioning portal by having the installer subscribe to the CTS job number at block 314. Additionally, or alternatively, the CTS 110 may cause the test status report WS endpoint 122 of the CTS WS gateway 112 to generate the CTS job number and the status updates.

At block 316, the CTS 110 may determine whether the DER device 128 is registered with the utility server 126 and communicating with the energy system 130 using protocol of the client, for example, by checking the utility server 126 for the status and/or activities of the DER device 128. In response to determining that the DER device 128 is not registered with the utility server 126 or communicating with the energy system 130 using the protocol of the client (“No” branch) at block 316, the CTS 110 may abort the testing and provide a notification of the DER device 128 not being registered or communicating via the installer commissioning portal at block 318. At block 320, the installer may correct defects, such as incorrect information associated with the DER device 128, and the process may be repeated from block 302, where the installer May re-initiate the client testing. In response to determining that the DER device 128 is registered with the utility server 126 and communicating with the energy system 130 using the protocol of the client (“Yes” branch) at block 314, the CTS 110 may set, or cause the utility server 126 to set, a test polling rate and a test posting rate of the DER device 128 and store the test polling rate and the test posting rate at block 322. For example, the CTS 110 may utilize the configuration WS endpoint 120 to cause the utility server 126 to set the test polling rate and the test posting rate.

At block 324, the CTS 110 may set, or cause the utility server 126 to set by utilizing the configuration WS endpoint 120, a current plurality of pre-conditions associated with a current test of the client testing. That is, when the client testing is initiated, a first plurality of pre-conditions is set as the current plurality of pre-conditions and a first test, or a first suite, of the client testing is set as the current test, and if the client testing is not completed, the next (second, third, fourth, . . . ) plurality of pre-conditions is set as the current plurality and next test of the client testing is set as the current test, until the client testing is completed. Such queuing of the tests may be coordinated by utilizing the CTS execution WS endpoint 124 for execution into the distributed event streaming platform 114. The container orchestration system 116 may automatically read requests from the distributed event streaming platform 114 and execute the test, or the test suite, one at a time, queued in a defined order and using defined parameters.

The pre-conditions may include the DER device 128 being configured with uniform resource identifier (URI) information of the utility server 126, the DER device 128 having obtained necessary connection details, the DER device 128 having successfully registered with the utility server 126, etc. Additionally, the CTS 110 may cause the test status report WS endpoint 122 to indicate and/or report, for example, by displaying through the use of the installer commissioning portal, the job status that the client testing has started at block 326. The CTS 110 may monitor, and receive from the utility server 126, readings and responses associated with the first (current) plurality of pre-conditions at block 328.

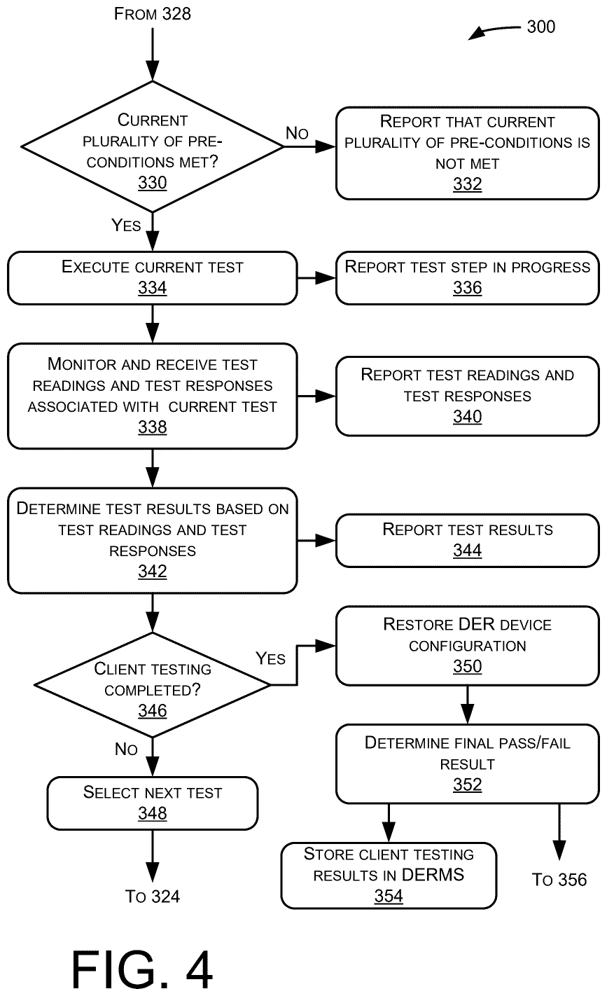

Referring to FIG. 4, which illustrates a second portion of the flowchart 300 continuing from FIG. 3, the CTS 110 may determine whether the first (current) plurality of pre-conditions is met based on the readings and responses from the utility server 126 at block 330. In response to determining that the first (current) plurality of pre-conditions is not met at block 330 (“No” branch), the CTS 110 may cause the test status report WS endpoint 122 to indicate and/or report, for example, by displaying through the use of the installer commissioning portal, the job status that the current plurality of pre-conditions is not met at block 332. In response to determining that the first (current) plurality of pre-conditions is met at block 330 (“Yes” branch), the CTS 110 may execute, or cause utility server 126 to execute, by way of the CTS execution WS endpoint 124, the first (current) test at block 334. The CTS 110 may cause the test status report WS endpoint 122 to report, for example, by displaying through the use of the installer commissioning portal, the test step in progress at block 336. The CTS 110 May monitor, and receive from the utility server 126, test readings and test responses associated with the first (current) test at block 338, and the CTS 110 may cause the test status report WS endpoint 122 to report, for example, by displaying through the use of the installer commissioning portal, the readings and responses associated with the first (current) test at block 340.

At block 342, The CTS 110 may determine test results based on the test readings and test responses, and may cause the test status report WS endpoint 122 to report, for example, by displaying through the use of the installer commissioning portal, the test results at block 344. At block 346, the CTS 110 may determine whether the client testing has been completed, for example, by way of the test status report WS endpoint 122 or the CTS execution WS endpoint 124. In response to determining that the client testing has not been completed, the CTS 110, by way of the CTS execution WS endpoint 124 for example, may select the next test, such as the second test of the one or more tests of the client testing, as the current test, at block 348, and the process may be repeated from block 324. In response to determining that the client testing has been completed, the CTS 110, may cause, by way of the configuration WS endpoint 120, the utility server 126 to automatically restore the configuration of the DER device 128 at block 350. At block 352, the CTS 110 may determine, by way of the CTS execution WS endpoint 124, a final pass/fail result, and results from the client testing are stored in the DERMS at block 354.

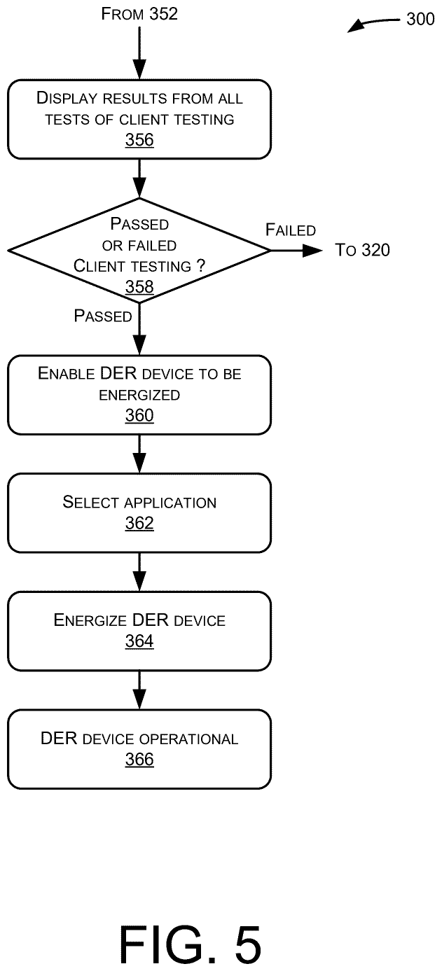

Referring to FIG. 5, which illustrates a third portion of the flowchart 300 continuing from FIG. 4, the CTS 110 may cause the CTS UI 102, by way of the test status report WS endpoint 122, to display the results from all tests of the one or more tests of the client testing at block 356. At block 358, if the DER device 128 has failed the client testing, the process may be repeated from block 320, where the installer may correct defects, such as incorrect information associated with the DER device 128, and the process may be repeated from block 302, where the installer may re-initiate the client testing. The DER device 128 may be prevented from being energized until passing the client testing. At block 358, if the DER device 128 has passed the client testing, the CTS 110 may enable the DER device 128 to be energized at block 360. The installer may select an application for the DER device 128 at block 362, and energize the DER device 128 at block 364. The DER device 128 may then be operational at block 366.

Some or all operations of the methods described above can be performed by execution of computer-readable instructions stored on a computer-readable storage medium, as defined below. The terms “computer-readable medium,” “computer-readable instructions,” “computer-executable instructions,” and “processor-executable instructions” as used in the description and claims, include routines, applications, application modules, program modules, programs, components, data structures, algorithms, and the like. Computer-readable and -executable instructions and processor-executable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (RAM)) and/or non-volatile memory (such as read-only memory (ROM), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions, such as the CTS 110, stored on one or more non-transitory computer-readable storage media, such as the CTS postgres database 108, when executed by one or more processors, such as the processors 134, may perform operations described above with reference to FIGS. 1-5. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

### Example Clauses

A. A method for testing an electrical device installed in an energy system, the method includes: receiving an identifier and a test identification (testID) associated with the electrical device; validating the identifier and the testID; determining whether the electrical device is registered and communicating; and in response to determining that the electrical device is registered and communicating: setting a polling rate and a posting rate of the electrical device, storing the polling rate and the posting rate, setting a first plurality of pre-conditions associated with a first test, determining whether the first plurality of pre-conditions is met, and in response to determining that the first plurality of pre-conditions is met, performing the first test by: executing a first set of test commands associated with the first test, receiving responses to the first set of test commands of the electrical device, determining first test results based on the responses to the first set of test commands, storing the first test results, and determining whether the electrical device has passed the first test.

B. The method of example A, wherein: the identifier is a long form device identifier (LFDI), and receiving the LFDI and the testID includes receiving the LFDI and the testID using an application programming interface (API) call.

C. The method of example B, wherein validating the LFDI and the testID includes: forwarding the LFDI to a utility server associated with the electrical device; receiving, from the utility server, comparison results of the LFDI compared to LFDIs stored in the utility server; and validating the LFDI and the testID based on the comparison results.

D. The method of example A, wherein the first test is part of a client testing, the method further including: determining whether the client testing has been completed; and in response to determining that the client testing has not been completed: setting a second plurality of pre-conditions associated with a second test of the client testing, monitoring the second plurality of pre-conditions, determining whether the second plurality of pre-conditions is met, and in response to determining that the second plurality of pre-conditions is met, performing the second test by: executing a second set of test commands associated with the second test, monitoring reading and responses to the second set of test commands of the electrical device, determining second test results based on the responses to the second set of test commands, storing the second test results, and determining whether the electrical device has passed the second test.

E. The method of example D, further including: in response to determining that the client testing has been completed: automatically restoring original configuration of the electrical device, determine whether the electrical device has passed the client testing, and in response to determining that the electrical device has passed the client testing: aborting the client testing, and energizing the electrical device.

F. The method of example E, further including: in response to determining that the electrical device has not passed the client testing: correcting defects associated with the electrical device not passing the client testing, and repeating a process from receiving the identifier and the testID of the electrical device with the defects corrected.

G. The method of example F, wherein at least a portion of the method is performed by at least one of: an original equipment manufacturer portal; an aggregator server portal; a compliance test suite; a utility server; or a utility back office.

H. The method of example A, wherein the electrical device is installed in an energy system associated with a customer, in which the electrical device is to be operated for the customer.

I. The method of example A, wherein the electrical device is a distributed energy resource (DER) device.

J. One or more computer-readable media storing thereon computer-readable instructions executable that, when executed by one or more processors associated with a system for testing an electrical device installed in an energy system, cause the one or more processors to perform operations, the operations including: receiving an identifier and a test identification (testID) associated with the electrical device; validating the identifier and the testID; determining whether the electrical device is registered and communicating; and in response to determining that the electrical device is registered and communicating: setting a polling rate and a posting rate of the electrical device, storing the polling rate and the posting rate, setting a first plurality of pre-conditions associated with a first test, determining whether the first plurality of pre-conditions is met, and in response to determining that the first plurality of pre-conditions is met, performing the first test by: executing a first set of test commands associated with the first test, receiving responses to the first set of test commands of the electrical device, determining first test results based on the responses to the first set of test commands, storing the first test results, and determining whether the electrical device has passed the first test.

K. The one or more computer-readable media of example J, wherein: the identifier is a long form device identifier (LFDI), and receiving the LFDI and the testID includes receiving the LFDI and the testID using an application programming interface (API) call.

L. The one or more computer-readable media of example K, wherein validating the LFDI and the testID includes: forwarding the LFDI to a utility server associated with the electrical device; receiving, from the utility server, comparison results of the LFDI compared to LFDIs stored in the utility server; and validating the LFDI and the testID based on the comparison results.

M. The one or more computer-readable media of example J, wherein the first test is part of a client testing, the operations further includes: determining whether the client testing has been completed; in response to determining that the client testing has not been completed: setting a second plurality of pre-conditions associated with a second test of the client testing, monitoring the second plurality of pre-conditions, determining whether the second plurality of pre-conditions is met, and in response to determining that the second plurality of pre-conditions is met, performing the second test by: executing a second set of test commands associated with the second test, monitoring reading and responses to the second set of test commands of the electrical device, determining second test results based on the responses to the second set of test commands, storing the second test results, and determining whether the electrical device has passed the second test, and in response to determining that the client testing has been completed: automatically restoring original configuration of the electrical device, determine whether the electrical device has passed the client testing, and in response to determining that the electrical device has passed the client testing: aborting the client testing, and energizing the electrical device.

N. The one or more computer-readable media of example M, wherein the operations further include: in response to determining that the electrical device has not passed the client testing: correcting defects associated with the electrical device not passing the client testing, and repeating a process from receiving the identifier and the testID of the electrical device with the defects corrected.

O. The one or more computer-readable media of example J, wherein the electrical device is a distributed energy resource (DER) device.

P. An electrical device testing system including: one or more computer-readable media communicatively coupled to the one or more processors, the one or more computer-readable media storing thereon computer-readable instructions executable that, when executed by the one or more processors, cause the one or more processors to perform operations, the operations including: receiving an identifier and a test identification (testID) associated with an electrical device installed in an energy system; validating the identifier and the testID; determining whether the electrical device is registered and communicating; and in response to determining that the electrical device is registered and communicating: setting a polling rate and a posting rate of the electrical device, storing the polling rate and the posting rate, setting a first plurality of pre-conditions associated with a first test, determining whether the first plurality of pre-conditions is met, and in response to determining that the first plurality of pre-conditions is met, performing the first test by: executing a first set of test commands associated with the first test, receiving responses to the first set of test commands of the electrical device, determining first test results based on the responses to the first set of test commands, storing the first test results, and determining whether the electrical device has passed the first test.

Q. The electrical device testing system of example P, wherein: the identifier is a long form device identifier (LFDI), and validating the LFDI and the testID includes: forwarding the LFDI to a utility server associated with the electrical device; receiving, from the utility server, comparison results of the LFDI compared to LFDIs stored in the utility server; and validating the LFDI and the testID based on the comparison results.

R. The electrical device testing system of example P, wherein the first test is part of a client testing, the operations further include: determining whether the client testing has been completed; in response to determining that the client testing has not been completed: setting a second plurality of pre-conditions associated with a second test of the client testing, monitoring the second plurality of pre-conditions, determining whether the second plurality of pre-conditions is met, and in response to determining that the second plurality of pre-conditions is met, performing the second test by: executing a second set of test commands associated with the second test, monitoring reading and responses to the second set of test commands of the electrical device, determining second test results based on the responses to the second set of test commands, storing the second test results, and determining whether the electrical device has passed the second test, and in response to determining that the client testing has been completed: automatically restoring original configuration of the electrical device, determine whether the electrical device has passed the client testing, and in response to determining that the electrical device has passed the client testing: aborting the client testing, and energizing the electrical device.

S. The electrical device testing system of example R, wherein the operations further include: in response to determining that the electrical device has not passed the client testing: correcting defects associated with the electrical device not passing the client testing, and repeating a process from receiving the identifier and the testID of the electrical device with the defects corrected.

T. The electrical device testing system of example P, wherein the electrical device is a distributed energy resource (DER) device.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for testing an electrical device installed in an energy system, the method comprising:
receiving an identifier and a test identification (testID) associated with the electrical device;
validating the identifier and the testID;
determining whether the electrical device is registered and communicating; and
in response to determining that the electrical device is registered and communicating:
setting a polling rate and a posting rate of the electrical device,
storing the polling rate and the posting rate,
setting a first plurality of pre-conditions associated with a first test,
determining whether the first plurality of pre-conditions is met, and
in response to determining that the first plurality of pre-conditions is met, performing the first test by:
executing a first set of test commands associated with the first test,
receiving responses to the first set of test commands of the electrical device,
determining first test results based on the responses to the first set of test commands,
storing the first test results, and
determining whether the electrical device has passed the first test.

2. The method of claim 1, wherein:
the identifier is a long form device identifier (LFDI), and
receiving the LFDI and the testID includes receiving the LFDI and the testID using an application programming interface (API) call.

3. The method of claim 2, wherein validating the LFDI and the testID includes:
forwarding the LFDI to a utility server associated with the electrical device;
receiving, from the utility server, comparison results of the LFDI compared to LFDIs stored in the utility server; and
validating the LFDI and the testID based on the comparison results.

4. The method of claim 1, wherein the first test is part of a client testing, the method further comprising:
determining whether the client testing has been completed; and
in response to determining that the client testing has not been completed:
setting a second plurality of pre-conditions associated with a second test of the client testing,
monitoring the second plurality of pre-conditions,
determining whether the second plurality of pre-conditions is met, and
in response to determining that the second plurality of pre-conditions is met, performing the second test by:
executing a second set of test commands associated with the second test,
monitoring reading and responses to the second set of test commands of the electrical device,
determining second test results based on the responses to the second set of test commands,
storing the second test results, and
determining whether the electrical device has passed the second test.

5. The method of claim 4, further comprising:
in response to determining that the client testing has been completed:
automatically restoring original configuration of the electrical device,
determine whether the electrical device has passed the client testing, and
in response to determining that the electrical device has passed the client testing:
aborting the client testing, and
energizing the electrical device.

6. The method of claim 5, further comprising:
in response to determining that the electrical device has not passed the client testing:
correcting defects associated with the electrical device not passing the client testing, and
repeating a process from receiving the identifier and the testID of the electrical device with the defects corrected.

7. The method of claim 6, wherein at least a portion of the method is performed by at least one of:
an original equipment manufacturer portal;
an aggregator server portal;
a compliance test suite;
a utility server; or
a utility back office.

8. The method of claim 1, wherein the electrical device is installed in an energy system associated with a customer, in which the electrical device is to be operated for the customer.

9. The method of claim 1, wherein the electrical device is a distributed energy resource (DER) device.

10. One or more computer-readable media storing thereon computer-readable instructions executable that, when executed by one or more processors associated with a system for testing an electrical device installed in an energy system, cause the one or more processors to perform operations, the operations comprising:
receiving an identifier and a test identification (testID) associated with the electrical device;
validating the identifier and the testID;
determining whether the electrical device is registered and communicating; and
in response to determining that the electrical device is registered and communicating:
setting a polling rate and a posting rate of the electrical device,
storing the polling rate and the posting rate,
setting a first plurality of pre-conditions associated with a first test,
determining whether the first plurality of pre-conditions is met, and
in response to determining that the first plurality of pre-conditions is met, performing the first test by:
executing a first set of test commands associated with the first test,
receiving responses to the first set of test commands of the electrical device,
determining first test results based on the responses to the first set of test commands,
storing the first test results, and
determining whether the electrical device has passed the first test.

11. The one or more computer-readable media of claim 10, wherein:
the identifier is a long form device identifier (LFDI), and
receiving the LFDI and the testID includes receiving the LFDI and the testID using an application programming interface (API) call.

12. The one or more computer-readable media of claim 11, wherein validating the LFDI and the testID includes:
forwarding the LFDI to a utility server associated with the electrical device;
receiving, from the utility server, comparison results of the LFDI compared to LFDIs stored in the utility server; and
validating the LFDI and the testID based on the comparison results.

13. The one or more computer-readable media of claim 10, wherein the first test is part of a client testing, the operations further comprise:
determining whether the client testing has been completed;
in response to determining that the client testing has not been completed:
setting a second plurality of pre-conditions associated with a second test of the client testing,
monitoring the second plurality of pre-conditions,
determining whether the second plurality of pre-conditions is met, and
in response to determining that the second plurality of pre-conditions is met, performing the second test by:
executing a second set of test commands associated with the second test,
monitoring reading and responses to the second set of test commands of the electrical device,
determining second test results based on the responses to the second set of test commands,
storing the second test results, and
determining whether the electrical device has passed the second test, and
in response to determining that the client testing has been completed:
automatically restoring original configuration of the electrical device,
determine whether the electrical device has passed the client testing, and
in response to determining that the electrical device has passed the client testing:
aborting the client testing, and
energizing the electrical device.

14. The one or more computer-readable media of claim 13, wherein the operations further comprise:
in response to determining that the electrical device has not passed the client testing:
correcting defects associated with the electrical device not passing the client testing, and
repeating a process from receiving the identifier and the testID of the electrical device with the defects corrected.

15. The one or more computer-readable media of claim 10, wherein the electrical device is a distributed energy resource (DER) device.

16. An electrical device testing system comprising:
one or more processors; and
one or more computer-readable media communicatively coupled to the one or more processors, the one or more computer-readable media storing thereon computer-readable instructions executable that, when executed by the one or more processors, cause the one or more processors to perform operations, the operations comprising:
receiving an identifier and a test identification (testID) associated with an electrical device installed in an energy system;
validating the identifier and the testID;
determining whether the electrical device is registered and communicating; and
in response to determining that the electrical device is registered and communicating:
setting a polling rate and a posting rate of the electrical device,
storing the polling rate and the posting rate,
setting a first plurality of pre-conditions associated with a first test,
determining whether the first plurality of pre-conditions is met, and
in response to determining that the first plurality of pre-conditions is met, performing the first test by:
executing a first set of test commands associated with the first test,
receiving responses to the first set of test commands of the electrical device,
determining first test results based on the responses to the first set of test commands,
storing the first test results, and
determining whether the electrical device has passed the first test.

17. The electrical device testing system of claim 16, wherein:
the identifier is a long form device identifier (LFDI), and
validating the LFDI and the testID includes:
forwarding the LFDI to a utility server associated with the electrical device;
receiving, from the utility server, comparison results of the LFDI compared to LFDIs stored in the utility server; and
validating the LFDI and the testID based on the comparison results.

18. The electrical device testing system of claim 16, wherein the first test is part of a client testing, the operations further comprise:
determining whether the client testing has been completed;
in response to determining that the client testing has not been completed:
setting a second plurality of pre-conditions associated with a second test of the client testing,
monitoring the second plurality of pre-conditions,
determining whether the second plurality of pre-conditions is met, and
in response to determining that the second plurality of pre-conditions is met, performing the second test by:
executing a second set of test commands associated with the second test,
monitoring reading and responses to the second set of test commands of the electrical device,
determining second test results based on the responses to the second set of test commands,
storing the second test results, and
determining whether the electrical device has passed the second test, and
in response to determining that the client testing has been completed:
automatically restoring original configuration of the electrical device,
determine whether the electrical device has passed the client testing, and
in response to determining that the electrical device has passed the client testing:
aborting the client testing, and
energizing the electrical device.

19. The electrical device testing system of claim 18, wherein the operations further comprise:
in response to determining that the electrical device has not passed the client testing:
correcting defects associated with the electrical device not passing the client testing, and
repeating a process from receiving the identifier and the testID of the electrical device with the defects corrected.

20. The electrical device testing system of claim 16, wherein the electrical device is a distributed energy resource (DER) device.
